(19) United States
(12) Patent Application Publication
(10) Pub. No.: US 2014/0169669 A1
(43) Pub. Date: Jun. 19, 2014

(54) TONE MAPPING METHOD OF HIGH DYNAMIC RANGE IMAGE/VIDEO

(71) Applicant: NATIONAL CHUNG CHENG UNIVERSITY, Min-Hsiung (TW)

(72) Inventors: Ching-Wei YEH, MIN-HSIUNG (TW); SHIUEN-SHIAN WANG, MIN-HSIUNG (TW)

(73) Assignee: NATIONAL CHUNG CHENG UNIVERSITY, MIN-HSIUNG (TW)

(21) Appl. No.: 13/720,304

(22) Filed: Dec. 19, 2012

(51) Int. Cl. G06T 9/00

(52) U.S. Cl. CPC G06T 9/00
USPC 382/166

(57) ABSTRACT

A tone mapping (TM) method of high dynamic range (HDR) image/video includes the steps of A) acquiring an HDR image/video; B) processing the HDR image/video via fast global TM where each of processed pixel outputs is denoted by Pixel_{FG} and then computing the HDR image/video via block-based GC algorithm where each of processed pixel outputs is denoted by Pixel_{BGC}; and C) computing the pixel outputs Pixel_{FG} and the pixel outputs Pixel_{BGC} that each pixel corresponds to respectively as presented by α×Pixel_{FG}+β×Pixel_{BGC} where the numeral values of α and β are between 0 and 1 each and α+β=1. After the computation, the result is the final output result.

### BACKGROUND OF THE INVENTION

1. Field of the Invention

The present invention relates generally to image processing techniques and more particularly, to a tone mapping (TM) method of high dynamic range (HDR) images/videos.

2. Description of the Related Art

There are still many differences between the current image/video and the real scene because of some major reasons, one of which is that the brightness dynamic range that most of the display devices or the like can support is much inferior to perception of human eyes. As the photosensitive element is developed further and the image processing technology progresses, the dynamic range of the image/video can be effectively enhanced to shorten the gap between the image/video and the real scene.

However, the existing display devices are limited to electronic components thereof to support low dynamic range only, so even though the image/videos can reach HDR via advanced photosensitive elements or advanced image processing technology, the HDR images/videos cannot be shown correctly straight on the display devices and need a TM process to compress the dynamic range in such a way that the original images/videos can be correctly shown on the display devices.

Among the existing TM algorithms, gradient compression-based (GC) algorithm is the good one. However, the GC algorithm involves calculation of gradient and decay function and needs solution to Poisson equation to have computational complexity. One still image needs much processing time. Thus, real-time video processing cannot depend on software only and needs hardware accelerator for auxiliary computation. In this way, the hardware cost is increased and the processing time is long, so the economic benefit is not available.

Because the GC algorithm is very complex, it is not applicable to hardware-based implementation of all computations in direct coordination with the frame size. The current solution is to partition the image into blocks and then compute every block, as known as block-based GC, in such a way that the hardware cost can be maintained within the acceptable range. Whether or not there is any overlap between the blocks, the universal solution is to find the largest block under the hardware-cost limitation to lessen the image/video quality deterioration resulting from the blocks. However, whatever the blocks are partitioned, the block-based GC will be deprived of the property of original global continual tone to further deteriorate the image/video quality. This problem has not been solved yet so far. Thus, the block-based GC is though the necessity of practical implementation, but the image/video quality becomes worse at the same time.

In addition, there another frame-based TM algorithms, which are simpler in computation and do not need a large number of hardware-based costs, such as [1] photographic “PH” TM algorithm proposed by E. Reinhard, M. Stark, P. Shirley, and J. Ferwerda and disclosed in the thesis titled “Photographic Tone Reproduction for Digital Images” published on Proc of SIGGRAPH in 2002, and [2] fast bilateral filtering proposed by F. Durand and J. Dorsey and disclosed in the thesis titled “Fast Bilateral Filtering for the Display of HDR Images” published on ACM Transactions on Graphics in 2002. Such frame-based TM algorithms though do not have the problem of deteriorated image/video though, but they still need hardware-based computational resource to certain degree. Thus, the frame-based TM algorithm and the block-based GC algorithm have respective advantages to be mutually complementary.

Since full-scale prevalence of the HDR image/video has become a sure trend and real-time and prompt display of the HDR image/video is also indispensable, every device having the real-time and high-quality TM computational capability is commercially potential. The present invention is proposed pursuant to such trend.

### SUMMARY OF THE INVENTION

The primary objective of the present invention is to provide a TM method of HDR image/video, which combines the block-based GC algorithm and the frame-based TM algorithm and can simplify computation and enhance image/video quality to further reduce hardware requirement and to process the image/video promptly.

The foregoing objective of the present invention is attained by the TM method having the steps of A) acquiring an HDR image/video formed of a plurality of frames, each of which is formed of a plurality of pixels; B) processing the HDR image/video via fast global TM where each of processed pixel outputs is denoted by Pixel_{FG} and the pixel outputs Pixel_{FG} to which the pixels correspond respectively are uncertainly identical to one another; and then partitioning the HDR image/video into a plurality of blocks and computing each of the blocks via the block-based GC algorithm where each of processed pixel outputs is denoted by Pixel_{BGC} and the pixel outputs Pixel_{BGC}to which the pixels correspond respectively are uncertainly identical to one another; and C) computing the pixel outputs Pixel_{FG} and the pixel outputs Pixel_{BGC} that each pixel corresponds to respectively as presented by α×Pixel_{FG}+β×Pixel_{BGC} where the numeral values of α and β are between 0 and 1 each and α+β=1; after the computation, the result is the final output result.

Preferably, in the step C), the numeral values of α and β are dynamically changeable subject to different blocks or frames as long as they are between 0 and 1 and α+β=1.

Preferably, in the step B) the fast global TM indicates a frame-based processing method aimed straight at the whole frame where the computational complexity does not exceed the block-based GC algorithm.

Preferably, the fast global TM is the PH TM or the fast bilateral filtering.

### BRIEF DESCRIPTION OF THE DRAWINGS

FIG. 1 is a flow chart of a preferred embodiment of the present invention.

### DETAILED DESCRIPTION OF PREFERRED EMBODIMENTS

The present invention will become more fully understood by reference to a preferred embodiment given hereunder. However, it is to be understood that the embodiment are given by way of illustration only, thus are not limitative of the claim scope of the present invention.

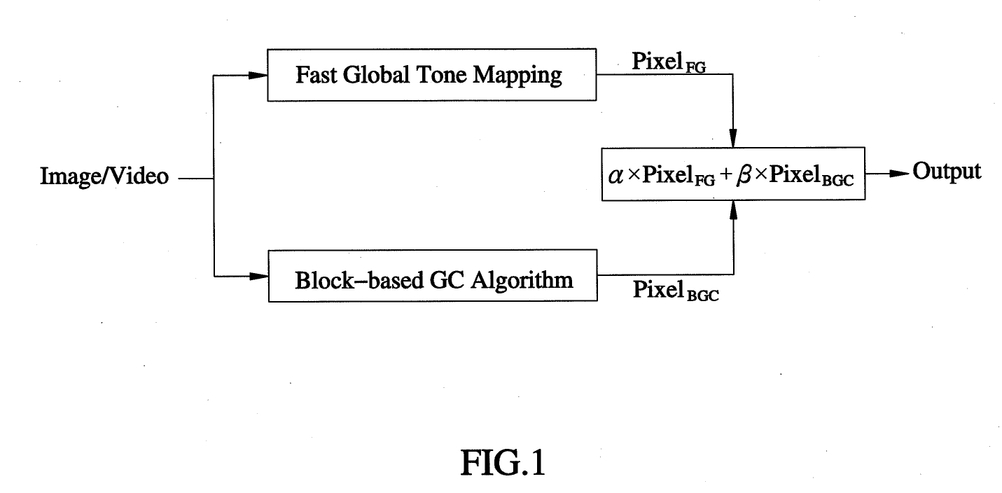

Referring to FIG. 1, a TM method of HDR image/video in accordance with a preferred embodiment of the present invention includes the following steps.

A) Acquire an HDR image/video formed of a plurality of frames, each of which is formed of a plurality of pixels.

B) Process the HDR image/video via fast global TM where each of processed pixel outputs is denoted by Pixel_{FG} and the pixel outputs Pixel_{FG} that the pixel correspond to respectively are uncertainly the same. Partition the HDR image/video into a plurality of blocks and then compute each of the blocks via block-based GC algorithm where each of processed pixel outputs is denoted by Pixel_{BGC} and the pixel outputs Pixel_{BGC} that the pixel correspond to respectively are uncertainly the same. In this embodiment, the fast global TM indicates a frame-based processing method aimed straight at the whole frame where the computational complexity does not exceed the block-based GC algorithm. For example, the fast global TM can be PH TM or fast bilateral filtering.

C) Compute the pixel outputs Pixel_{FG} and the pixel outputs Pixel_{BGC} that each pixel corresponds to as presented by α×Pixel_{FG}+β×Pixel_{BGC} where the numeral values of α and β are between 0 and 1 each and α+β=1. After the computation, the result is the final output result. In this embodiment, the numeral values of α and β are dynamically changeable subject to different blocks or frames as long as they are between 0 and 1 and α+β=1.

In light of the above steps, the fast global TM can result in the advantage—the whole frame can be processed without partitioned blocks to maintain the image/video quality, and the block-based GC algorithm can result in the advantage—prompt processing can be done in coordination with the limitation to hardware to further decrease the hardware requirement and lower the cost. Further, in consideration of weight distribution, i.e. proportion of α and β, the most appropriate image/video output result can be adjustably acquired. Thus, the present invention eliminates the limitation of the hardware cost in the prior art and solves the problem of deteriorated image/video quality resulting from the block-based GC algorithm.

In conclusion, the present invention can simplify the computation and enhance the image/video quality to further decrease hardware requirement and process the image/video promptly.

What is claimed is:

1. A tone mapping (TM) method of high dynamic range (HDR) image/video, comprising steps of
A) acquiring an HDR image/video formed of a plurality of frames, each of which is formed of a plurality of pixels;
B) processing the HDR image/video via fast global TM where each of processed pixel outputs is denoted by Pixel_{FG} and the pixel outputs Pixel_{FG} to which the pixels correspond respectively are uncertainly identical to one another, and then partitioning the HDR image/video into a plurality of blocks and computing each of the blocks via block-based gradient compression-based (GC) algorithm where each of processed pixel outputs is denoted by Pixel_{BGC} and the pixel outputs Pixel_{BGC} to which the pixels correspond respectively are uncertainly identical to one another; and
C) computing the pixel outputs Pixel_{FG} and the pixel outputs Pixel_{BGC} that the pixels correspond to respectively as presented by α×Pixel_{FG}+β×Pixel_{BGC} where the numeral values of α and β are between 0 and 1 each and α+β=1; after the computation, the result is the final output result.

2. The TM method as defined in claim 1, wherein in the step C), the numeral values of α and β are dynamically changeable subject to different blocks or frames as long as they are between 0 and 1 and α+β=1.

3. The TM method as defined in claim 1, wherein in the step B), the fast global TM indicates a frame-based processing method aimed straight at the whole frame where the computational complexity does not exceed the block-based GC algorithm.

4. The TM method as defined in claim 3, wherein the fast global TM is the photographic (PH) TM or the fast bilateral filtering.
